(19) United States
(12) Patent Application Publication
(10) Pub. No.: US 2012/0327118 A1
(43) Pub. Date: Dec. 27, 2012

(54) DISPLAY CONTROL APPARATUS, DISPLAY CONTROL METHOD AND PROGRAM

(76) Inventor: Kenichirou OOI, Kanagawa (JP)

(21) Appl. No.: 13/495,606

(22) Filed: Jun. 13, 2012

(30) Foreign Application Priority Data
Jun. 21, 2011 (JP) 2011-137181

(51) Int. Cl. G09G 5/377

(52) U.S. Cl. 345/633

(57) ABSTRACT

There is provided a display control apparatus including a display control unit that adds a virtual display to a real object containing a region associated with a time. The display control unit may add the virtual display to the region.

### BACKGROUND

The present disclosure relates to a display control apparatus, a display control method, and a program.

In recent years, thanks to advanced image recognition technology, it has become possible to recognize the position or posture of a real object (for example, an object such as a signboard and a building) contained in an input image from an imaging apparatus. As an application example of such object recognition, an augmented reality (AR) application is known. According to the AR application, a virtual object (for example, advertisement information, navigation information, or information for a game) associated with a real object can be superimposed on the real object contained in a real-space image. Such an AR application is disclosed by, for example, Japanese Patent Application No. 2010-238098.

### SUMMARY

If the user uses an AR application with a mobile terminal having an imaging function, the user can obtain useful information by browsing a virtual object added to a real object. However, if the user browses a real object containing a region (for example, a region associated with the time), no virtual object is added to the region and thus for the user, grasping the region to be noted becomes difficult and the convenience is decreased.

In view of the foregoing, the present disclosure proposes a novel and improved display control apparatus capable of improving convenience for the user, a display control method, and a program.

According to an embodiment of the present disclosure, there is provided a display control apparatus including a display control unit that adds a virtual display to a real object containing a region associated with a time. The display control unit may add the virtual display to the region.

According to an embodiment of the present disclosure, there is provided a display control method including adding a virtual display to a region of a real object containing the region associated with a time.

According to an embodiment of the present disclosure, there is provided a program causing a computer to function as a display control apparatus including a display control unit that adds a virtual display to a real object containing a region associated with a time. The display control unit may add the virtual display to the region.

As described above, according to a display control apparatus, a display control method, and a program in an embodiment of the present disclosure, convenience for the user can be improved.

### BRIEF DESCRIPTION OF THE DRAWINGS

FIG. 1 is an explanatory view showing a configuration of an AR system according to an embodiment of the present disclosure;

FIG. 2 is an explanatory view showing a hardware configuration of a mobile terminal;

FIG. 3 is a functional block diagram showing the configuration of the mobile terminal;

FIG. 4 is an explanatory view showing an example of region information;

FIG. 5 is an explanatory view showing an example of the configuration information;

FIG. 6 is an explanatory view showing an example of a method of recognizing a position and posture of a real object;

FIG. 7 is an explanatory view showing an example of a display of a virtual object;

FIG. 8 is an explanatory view showing another example of the display of the virtual object;

FIG. 9 is an explanatory view showing an example of an operation screen displayed by a user operation on the virtual object;

FIG. 10 is an explanatory view showing another example of the operation screen displayed by the user operation on the virtual object;

FIG. 11 is an explanatory view showing an example of the operation screen displayed by the user operation;

FIG. 12 is an explanatory view showing another example of the operation screen displayed by the user operation;

FIG. 13 is a sequence diagram showing an operation performed before a real object being imaged; and

FIG. 14 is a sequence diagram showing the operation after the real object being imaged.

### DETAILED DESCRIPTION OF THE EMBODIMENT

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Also in this specification and the appended drawings, a plurality of structural elements that has substantially the same function and structure may be distinguished by denoting with different alphabets after the same reference numerals. However, if it is not specifically necessary to distinguish each of the plurality of structural elements that has substantially the same function and structure, only the same reference numerals are attached.

The “DETAILED DESCRIPTION OF THE EMBODIMENT” will be described in the order of items shown below:

1. Overview of AR System

2. Description of Embodiment

3. Conclusion

### 1. Overview of AR System

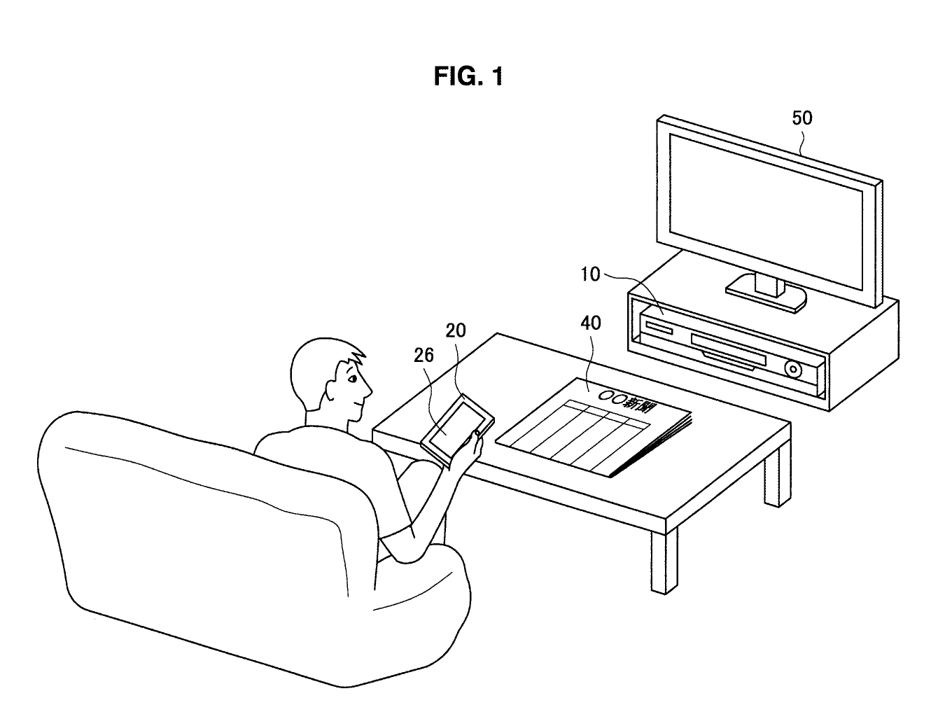

First, a basic configuration of an AR system according to an embodiment of the present disclosure will be described with reference to FIG. 1 below.

FIG. 1 is an explanatory view showing a configuration of an AR system according to an embodiment of the present disclosure. As shown in FIG. 1, an AR system according to the embodiment of the present disclosure contains a recording apparatus 10 and a mobile terminal 20. The mobile terminal 20 captures a real-space image and can add a virtual object (hereinafter, referred to also as a “virtual display”) corresponding to a real object contained in the real-space image to the real object. The virtual object can be displayed in a display 26. The real object may be the real-space image or the real space itself.

If, for example, the real object is a program table 40 as shown in FIG. 1, the mobile terminal 20 can add a virtual object corresponding to the program table 40 to the real object by imaging the real space containing the program table 40. The virtual object can be displayed in the display 26. The user can grasp information not available from the real space by visually recognizing such virtual object.

The mobile terminal 20 can also control execution of processing in accordance with a user operation. Processing in accordance with the user operation may be performed by the mobile terminal 20 or an apparatus (for example, the recording apparatus 10) that receives a command from the mobile terminal 20. If, for example, a user operation indicating that recording of a program should be reserved is performed, the mobile terminal 20 can control a recording reservation of the program. When the user operation indicating that recording of a program should be reserved is performed, the mobile terminal 20 transmits a command to perform a recording reservation of a program to the recording apparatus 10 and the recording apparatus 10 that has received the command can perform a recording reservation of the program.

When, for example, a recorded program is played back by the recording apparatus 10, a display apparatus 50 can display the played-back program. Incidentally, the display apparatus 50 is not an indispensable apparatus for the embodiment of the present disclosure.

A smart phone is shown in FIG. 1 as an example of the mobile ten final 20, but the mobile terminal 20 is not limited to the smart phone. For example, the mobile terminal 20 may be personal digital assistants (PDA), mobile phone, mobile music playback apparatus, mobile video processing apparatus, or mobile game machine. Further, the mobile terminal 20 is only an example of the display control apparatus and the display control apparatus may be a server provided on the side of a network.

In FIG. 1, the program table 40 is shown as an example of the real object, but the real object is not limited to the program table 40. For example, the real object may be, like the program table 40, a table (for example, a calendar or schedule table) containing a region associated with the time.

Incidentally, the above AR application can add a virtual object to a real object. However, even if a region associated with the time is contained in a real object, it is difficult to add a virtual object to the region. If a virtual object is added to a region associated with the time, user convenience will be increased. If, for example, a virtual object is added to a program column of the program table 40, it becomes easier for the user to identify noteworthy programs.

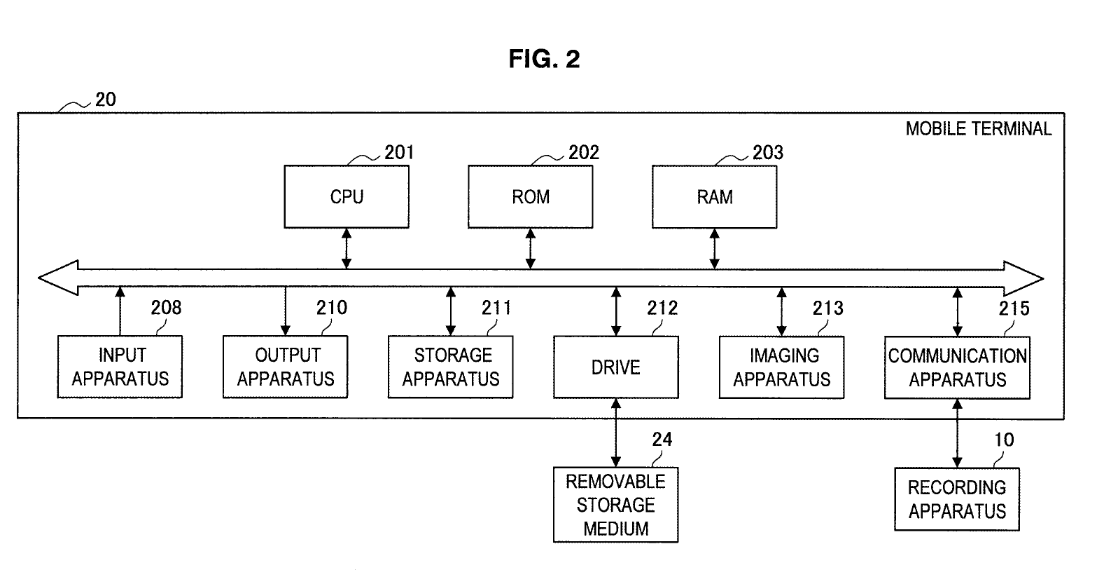

Therefore, focusing on the above circumstances led to the creation of the embodiment of the present disclosure. According to the embodiment of the present disclosure, convenience of the mobile terminal 20 for the user can be enhanced. The hardware configuration of the mobile terminal 20 will be described with reference to FIG. 2 and then, the embodiment of the present disclosure will be described in detail.

(Hardware Configuration of the Mobile Terminal)

FIG. 2 is an explanatory view showing the hardware configuration of the mobile terminal 20. As shown in FIG. 2, the mobile terminal 20 includes a central processing unit (CPU) 201, a read only memory (ROM) 202, a random access memory (RAM) 203, an input apparatus 208, an output apparatus 210, a storage apparatus 211, a drive 212, an imaging apparatus 213, and a communication apparatus 215.

The CPU 201 functions as an arithmetic processing unit and control apparatus and controls overall operations of the mobile terminal 20 according to various programs. The CPU 201 may also be a microprocessor. The ROM 202 stores programs and operation parameters used by the CPU 201. The RAM 203 temporarily stores a program used for execution of the CPU 201 and parameters that suitably change during execution thereof. These elements are mutually connected by a host bus constructed from a CPU bus or the like.

The input apparatus 208 includes an input unit used by the user to input information such as a mouse, keyboard, touch panel, button, microphone, switch, and lever and an input control circuit that generates an input signal based on input from the user and outputs the input signal to the CPU 201. The user of the mobile terminal 20 can input various kinds of data into the mobile terminal 20 or instruct the mobile terminal 20 to perform a processing operation by operating the input apparatus 208.

The output apparatus 210 includes, for example, a display apparatus such as a liquid crystal display (LCD) apparatus, organic light emitting diode (OLED) apparatus, and lamp. Further, the output apparatus 210 includes a sound output apparatus such as a speaker and headphone. For example, the display apparatus displays captured images or generated images. On the other hand, the sound output apparatus converts sound data or the like into sound and outputs the sound.

The storage apparatus 211 is an apparatus for data storage configured as an example of a storage unit of the mobile terminal 20 according to the present embodiment. The storage apparatus 211 may contain a storage medium, a recording apparatus that records data in the storage medium, a reading apparatus that reads data from the storage medium, or a deletion apparatus that deletes data recorded in the storage medium. The storage apparatus 211 stores programs executed by the CPU 201 and various kinds of data.

The drive 212 is a reader/writer for a storage medium and is attached to the mobile terminal 20 internally or externally. The drive 212 reads information stored in a removable storage medium 24 such as an inserted magnetic disk, optical disk, magneto-optical disk, and semiconductor memory and outputs the information to the RAM 203. The drive 212 can also write data into the removable storage medium 24.

The imaging apparatus 213 includes an imaging optical system such as a shooting lens that condenses light and a zoom lens and a signal conversion element such as a charge coupled device (CCD) and complementary metal oxide semiconductor (CMOS). The imaging optical system condenses light emitted from a subject to form a subject image in a signal conversion unit and the signal conversion element converts the formed subject image into an electric image signal.

The communication apparatus 215 is, for example, a network interface configured by a communication device or the like to be connected to a network. The communication apparatus 215 may be a wireless local area network (LAN) compatible communication apparatus, long term evolution (LTE) compatible communication apparatus, or wired communication apparatus that performed communication by wire. The communication apparatus 215 can perform communication with the recording apparatus 10, for example, via the network.

The network is a wired or wireless transmission path of information transmitted from an apparatus connected to the network. The network may include, for example, a public network such as the Internet, a telephone network, and a satellite communication network or various kinds of local area network (LAN) or wide area network (WAN) including Ethernet (registered trademark). The network may also include a leased line network such as internet protocol-virtual private network (IP-VPN).

### 2. Description of Embodiment

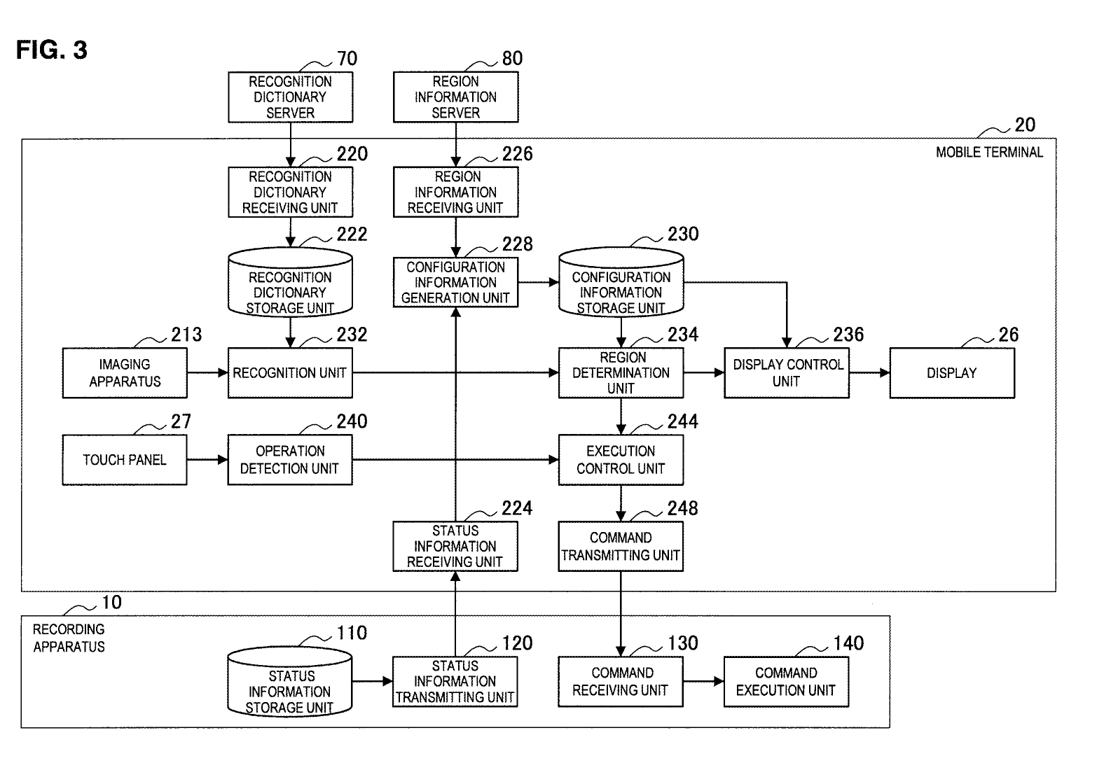

In the foregoing, the basic configuration of an AR system according to the embodiment of the present disclosure has been described with reference to FIGS. 1 and 2. The embodiment according to the present disclosure will be described in detail below with reference to FIGS. 3 to 14.

(Configuration of the Mobile Terminal)

FIG. 3 is a functional block diagram showing the configuration of the mobile terminal 20 according to the present embodiment. As shown in FIG. 3, the mobile terminal 20 according to the present embodiment includes the display 26, a touch panel 27, the imaging apparatus 213, a recognition dictionary receiving unit 220, a recognition dictionary storage unit 222, a status information receiving unit 224, and a region information receiving unit 226. The mobile terminal 20 according to the present embodiment also includes a configuration information generation unit 228, a configuration information storage unit 230, a recognition unit 232, a region determination unit 234, a display control unit 236, an operation detection unit 240, an execution control unit 244, and a command transmitting unit 248.

The display 26 is a display module constructed from an LCD, an OLED or the like. The display 26 displays various screens according to the control by the display control unit 236. For example, the display 26 can display a virtual object added to a real object. If the real object is a real-space image (a real-space still image or real-space motion image), the real-space image can also be displayed. The real-space image may be an image of space imaged presently or an image of real space imaged in the past.

An example in which the display 26 is implemented as a portion of the mobile terminal 20 is shown in FIG. 3, but the display 26 may be configured separately from the mobile terminal 20. The display 26 may also be a head mounted display (HMD) mounted on the head of the user.

The touch panel 27 may be laminated in the display 26 or arranged in a place apart from the display 26. The touch panel 27 can detect proximity or contact of an operation body such as a user's finger and touch pen. The operation detection unit 240 is notified of proximity or contact of an operation body detected by the touch panel 27 as a user operation. Incidentally, the touch panel 27 may contain other operation components such as the keyboard and button of the mobile terminal 20.

The imaging apparatus 213 includes an imaging optical system and a signal conversion element and acquires a captured image (a motion image or still image) by imaging a real space. The imaging apparatus 213 may include motion image capturing components and still image capturing components separately.

The recognition dictionary receiving unit 220 receives a recognition dictionary used to recognize a real object from a recognition dictionary server 70. The recognition dictionary receiving unit 220 receives a recognition dictionary from, for example, the recognition dictionary server 70 via a network. The network used here may be the same network as the network to which the recording apparatus 10 is connected or a different network. More specifically, identification information to identify each real object and characteristic quantity data of each real object are associated in the recognition dictionary. The characteristic quantity data may be, for example, a set of characteristic quantities decided based on a learning image of a real object according to the SIFT method or Random Ferns method.

The recognition dictionary storage unit 222 stores a recognition dictionary. The recognition dictionary storage unit 222 can store, for example, a recognition dictionary received by the recognition dictionary receiving unit 220. However, recognition dictionaries stored in the recognition dictionary storage unit 222 are not limited to the recognition dictionaries received by the recognition dictionary receiving unit 220. For example, the recognition dictionary storage unit 222 may store a recognition dictionary read from a storage medium.

The status information receiving unit 224 receives status information from the recording apparatus 10. The status information is information indicating the status of a program and is indicated by, for example, the recording reservation status (for example, reserved, recorded, non-reserved and the like) of the program. The recording apparatus 10 includes a status information storage unit 110, a status information transmitting unit 120, a command receiving unit 130, and a command execution unit 140. The status information storage unit 110 stores status information and the status information transmitting unit 120 transmits status information stored in the status information storage unit 110 to the mobile terminal 20 via a network. The command receiving unit 130 and the command execution unit 140 will be described later.

The region information receiving unit 226 receives region information from a region information server 80. The region information receiving unit 226 receives region info nation from the region information server 80, for example, via a network. The network used here may be the same network as the network to which the recording apparatus 10 is connected or a different network. The network used here may also be the same network as the network to which the recognition dictionary server 70 is connected or a different network.

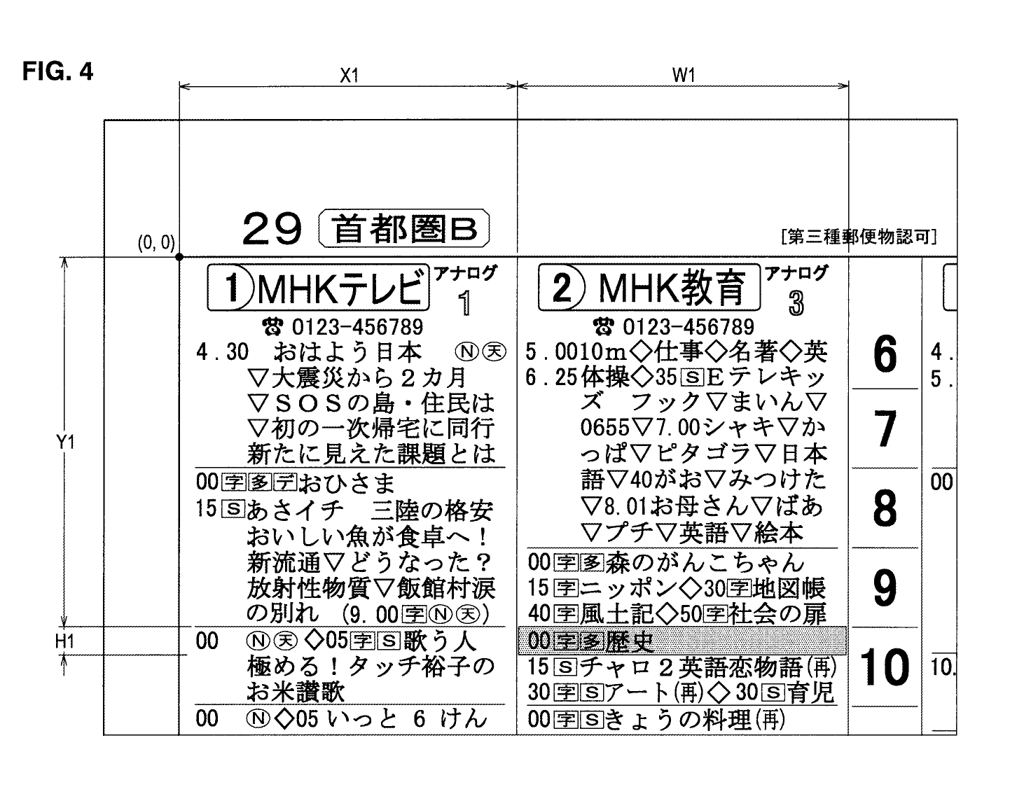

An example of the region information will be described with reference to FIG. 4. FIG. 4 is an explanatory view showing an example of the region information. The region information is information indicating the position and size of region contained in a real object. The position of a region can be represented by the position of a prescribed point of the region when, for example, the position of the prescribed point of a real object is set as the reference.

In the example shown in FIG. 4, the upper left corner of a real object is set as the prescribed point of the real object, but the prescribed point of a real object does not have to be the upper left corner of the real object. Also in the example shown in FIG. 4, the upper left corner of the region is set as the prescribed point of the region, but the prescribed point of a region does not have to be the upper left corner of the region. Also in the example shown in FIG. 4, the position of the prescribed point of a real object is represented as (0. 0), the position of the prescribed point of a region is represented as (X1. Y1), and the size of the region is represented as (W1, H1), but the form of representation is not specifically limited. For example, these values (X1, Y1, W1, H1) may be represented in the absolute unit (for example, the same unit as the actual size of a real object) or in the relative unit (for example, a relative value when the horizontal or vertical size of a real object is set to 1).

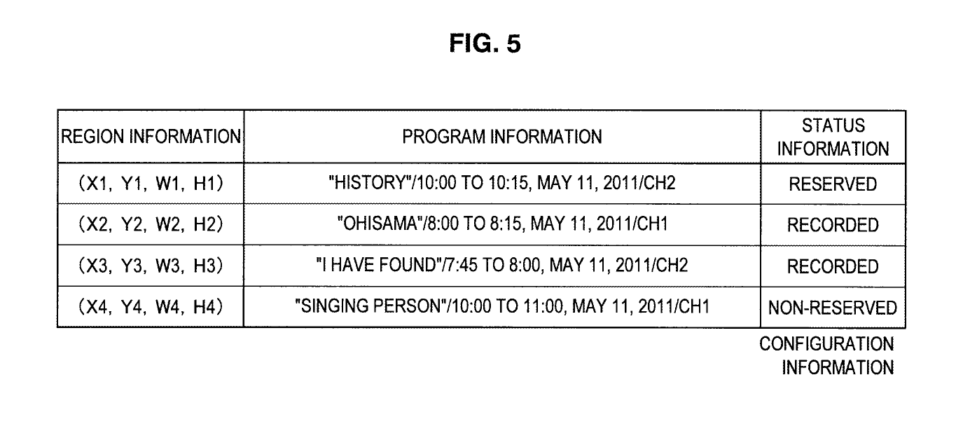

The configuration information generation unit 228 generates configuration information based on status information received by the status information receiving unit 224 and region information received by the region information receiving unit 226. An example of the configuration information will be described with reference to FIG. 5. FIG. 5 is an explanatory view showing an example of the region information. If, for example, associated information is present between status information received by the status information receiving unit 224 and region information received by the region information receiving unit 226, the configuration information generation unit 228 can generate configuration information by associating the associated information.

If, for example, program information (for example, broadcasting hours of a program and the channel of the program) is added to status information received by the status information receiving unit 224 and program information is added to region information received by the region information receiving unit 226, the status information and the region information to which the same program information is added are determined to be associated and configuration information can be generated by associating the status information and the region information. As shown in FIG. 5, program information may contain, in addition to broadcasting hours of a program and the channel of the program, a program title. Instead of the program information, information to identify a program such as the G code may be used.

The description will continue by returning to FIG. 3. The configuration information storage unit 230 stores configuration information. For example, the configuration information storage unit 230 can store configuration information generated by the configuration information generation unit 228. However, configuration information stored in the configuration information storage unit 230 is not limited to the configuration information generated by the configuration information generation unit 228. For example, the configuration information storage unit 230 may store configuration information read from a storage medium. Instead, the configuration information storage unit 230 may also store configuration information received from a predetermined server.

The recognition unit 232 recognizes a real object contained in a real-space image captured by the imaging apparatus 213 and the position and posture in the real-space image of the real object. For example, the recognition unit 232 recognizes the real object contained in the real-space image by checking the characteristic quantity decided from the real-space image against the characteristic quantity of each real object contained in the recognition dictionary storage unit 222.

More specifically, the recognition unit 232 decides the characteristic quantity of the real object in the real-space image according to a characteristic quantity decision method such as the SIFT method or the Random Ferns method and checks the decided characteristic quantity against the characteristic quantity of each real object contained in the recognition dictionary storage unit 222. Then, the recognition unit 232 recognizes identification information of the real object associated with the characteristic quantity that matches the characteristic quantity of the real object in the real-space image most and also the position and posture in the real-space image.

Incidentally, recognition of a real object is not limited to such an example. For example, the recognition unit 232 may indirectly recognize a real object by recognizing a known figure or symbol or a marker such as an artificial marker (for example, a barcode or QR code) or natural marker associated with the real object. The recognition unit 232 may also recognize a real object such as a known figure or symbol or an artificial marker or natural marker to estimate the position and posture of the real object from the size and shape of the real object in a real-space image.

Examples in which the position and posture of a real object contained in a real-space image are recognized by image processing have been described above, but the method of recognizing the position and posture of a real object is not limited to image processing. For example, a real object contained in a real-space image and the position and posture of the real object in the real-space image can be estimated based on detection results of the direction in which the imaging apparatus 213 is directed and the current position of the mobile terminal 20.

Alternatively, the recognition unit 232 may recognize the position and posture of the real object according to a pinhole camera model. The pinhole camera model is the same as the projective transformation of a perspective method (perspective view) of OpenGL and an observation point model CG created by the perspective method can be made identical to the pinhole camera model.

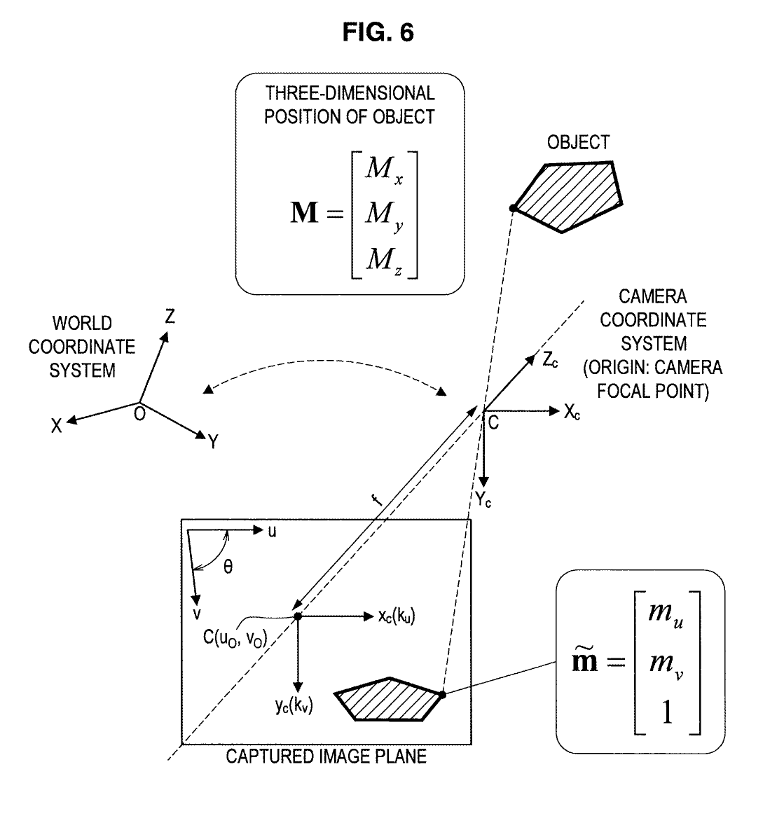

FIG. 6 is an explanatory view showing an example of a method of recognizing the position and posture of a real object and a diagram showing the method of recognizing the position and posture of a real object particularly according to the pinhole camera model. The method of recognizing the position and posture of a real object according to the pinhole camera model will be described below.

In the pinhole camera model, the position of a characteristic point in an image frame can be calculated by Formula (1) below:

[Math 1]

λ\tilde{m}=AR_{w}(M−C_{w}) (1)

Formula (1) is a formula that shows a correspondence between the pixel position in a captured image plane of a point (m) of an object contained in the captured image plane (that is, the position represented by a camera coordinate system) and a three-dimensional position (M) of the object in a world coordinate system. The pixel position in the captured image plane is represented by the camera coordinate system. The camera coordinate system is a coordinate system that represents the captured image plane as a two-dimensional plane of Xc, Yc by setting the focal point of the camera (imaging apparatus 213) as an origin C and represents the depth as Zc and the origin C moves depending on the movement of the camera.

On the other hand, the three-dimensional position (M) of an object is indicated by the world coordinate system made of three axes XYZ having an origin O that does not move depending on the movement of the camera. The formula showing the correspondence of positions of an object in these different coordinate systems is defined as the above pinhole camera model.

Each value contained in the formula means:

λ: Normalization parameter

A: Camera internal parameters

Cw: Camera position

Rw: Camera rotation matrix

Further, as shown in FIG. 6,

$$\begin{matrix}[ Math 2 ] & \\ \tilde{m} = [ \begin{matrix}{m}_{u} \\ {m}_{v} \\ 1\end{matrix} ] & ( 2 )\end{matrix}$$

is a position in the captured image plane represented by the camera coordinate system. λ is a normalization parameter and is a value to satisfy the third term of

[Math 3]

\tilde{m} (3)

The camera internal parameters A contain values shown below:

f: Focal length

θ: Orthogonality of image axes (ideally 90°)

ku: Scale of the vertical axis (conversion from the scale of a three-dimensional position to the scale of a two-dimensional image)

kv: Scale of the horizontal axis (conversion from the scale of a three-dimensional position to the scale of a two-dimensional image)

(u0, v0): Image center position

Thus, a characteristic point present in the world coordinate system is represented by the position [M]. The camera is represented by the position [Cw] and the posture (rotation matrix) Rw. The focal position, image center and the like of the camera are represented by the camera internal parameters [A]. The position [M], the position [Cw], and the camera internal parameters [A] can be represented by Formulas (4) to (6) shown below:

$$[ Math 4 ] \\ M = [ \begin{matrix}{M}_{x} \\ {M}_{y} \\ {M}_{z}\end{matrix} ] \qquad$$

$$\begin{matrix}[ Math 5 ] & \\ {C}_{w} = [ \begin{matrix}{C}_{x} \\ {C}_{y} \\ {C}_{z}\end{matrix} ] & ( 5 ) \\ [ Math 6 ] & \\ A = [ \begin{matrix}- f \cdot {k}_{u} & f \cdot {k}_{u} \cdot cot θ & {u}_{0} \\ 0 & - \frac{f \cdot {k}_{v}}{sin θ} & {v}_{0} \\ 0 & 0 & 1\end{matrix} ] & ( 6 )\end{matrix}$$

From these parameters, each position projected from a “characteristic point present in the world coordinate system” onto the “captured image plane” can be represented by Formula (1) shown above. The recognition unit 232 can calculate the position [Cw] and the posture (rotation matrix) Rw of the camera by applying, for example, the RANSAC based 3 point algorithm described in the following literature:

M. A. Fischler and R. C. Bolles, “Random sample consensus: A paradigm for model fitting with applications to image analysis and automated cartography”, Communications of the ACM. Volume 24 Issue 6 (1981)

If the mobile terminal 20 is equipped with a sensor capable of measuring the position and posture of the camera or a sensor capable of measuring changes in position and posture of the camera, the recognition unit 232 may acquire the position [Cw] and the posture (rotation matrix) Rw of the camera based on values detected by the sensor.

By applying such a method, the real object is recognized. If the real object is recognized by the recognition unit 232, the display control unit 236 may add a display indicating that the real object is recognized to the real object. If the user sees such a display, the user can grasp that a real object is recognized by the mobile terminal 20. The display indicating that a real object is recognized is not specifically limited. If, for example, the program table 40 is recognized by the recognition unit 232 as a real object, the display indicating that a real object is recognized may be a frame (for example, a green frame) enclosing the program table 40 or a display that fills the program table 40 with a transparent color.

If no real object is recognized by the recognition unit 232, the display control unit 236 may control the display 26 so that a display indicating that no real object is recognized is displayed. If the user sees such a display, the user can grasp that no real object is recognized by the mobile terminal 20. The display indicating that no real object is recognized is not specifically limited. For example, the display indicating that no real object is recognized may be “?” mark. The display control unit 236 may also control the display 26 so that a reduced image of an object that is not recognized is displayed next to the “?” mark.

A case when a real object is not uniquely recognized by the recognition unit 232 can also be assumed. In such a case, the display control unit 236 may cause the display 26 to display a plurality of real objects recognized by the recognition unit 232 as candidates. Then, if the user finds a desired real object from the plurality of real objects displayed by the display 26, the user can input an operation to select the desired object into the touch panel 27. The recognition unit 232 can recognize the real object based on the operation detected by the operation detection unit 240.

The description will continue by returning to FIG. 3. The region determination unit 234 determines a region contained in a real object in a captured image. The region determination unit 234 determines a region based on, for example, configuration information stored in the configuration information storage unit 230. For example, the region determination unit 234 can determine a region indicated by region information contained in configuration information as a region contained in a real object. The region determination unit 234 can also determine a region based on the position and posture of a real object recognized by the recognition unit 232 and region information contained in configuration information.

The display control unit 236 adds a virtual object to a real object containing a region associated with the time (for example, broadcasting hours). The display control unit 236 can add the virtual object to, for example, the region contained in the real object. The region contained in a real object can be determined by the region determination unit 234. If, for example, the virtual object is stored for each real object, the display control unit 236 can add the virtual object corresponding to the real object to the region.

The operation detection unit 240 detects an operation from the user. The operation detection unit 240 can detect a user operation input, for example, into the touch panel 27. However, input of the user operation may also be received by an input apparatus other than the touch panel 27. For example, the input apparatus may be a mouse, keyboard, touch panel, button, microphone, switch, or lever.

The execution control unit 244 controls execution of processing in accordance with the user operation. If, for example, a user operation on a virtual object is detected by the operation detection unit 240, the execution control unit 244 controls execution of processing corresponding to the virtual object. Such processing may be performed by the mobile terminal 20 or an apparatus (for example, the recording apparatus 10) other than the mobile terminal 20.

When the recording apparatus 10 is caused to perform processing, a command instructing execution of the processing is transmitted to the recording apparatus 10 by the command transmitting unit 248 of the mobile terminal 20 and the command is received by the command receiving unit 130 of the recording apparatus 10. When the command is received by the command receiving unit 130, the command execution unit 140 of the recording apparatus 10 performs the processing instructed by the received command. As the processing performed by the recording apparatus 10, the playback or deletion of a recorded program, recording reservation of a program, and cancel reservation of a program can be assumed.

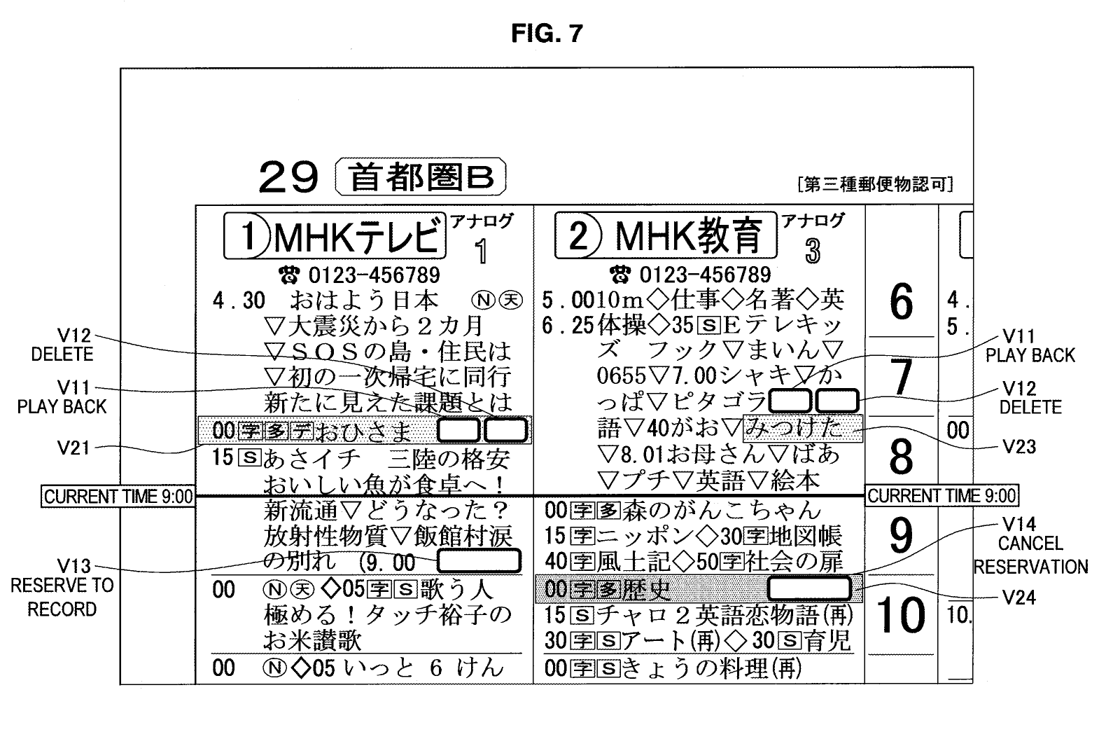

An example of the display of a virtual object will be described with reference to FIG. 7. FIG. 7 is an explanatory view showing an example of the display of a virtual object. If, as shown in FIG. 7, the real object is the program table 40, each of a plurality of regions is associated with broadcasting hours and the channel and, for example, the display control unit 236 can add virtual objects V21, V23, V24 to each region of the real object. In the example shown in FIG. 7, virtual objects that fill whole regions with a transparent color are added.

However, the display control unit 236 does not have to add a virtual object to a whole region of the real object. For example, the display control unit 236 may add a virtual object to a portion of the real object or add a virtual object to a tip of a leader line extending from the region.

The display control unit 236 may add the same virtual object to each region, but may also add the virtual object in accordance with stored information on a program to the region corresponding to the program. In the example shown in FIG. 7, the display control unit 236 adds virtual objects V11, V12 corresponding to “recorded” to regions corresponding to programs whose status information is “recorded”. The display control unit 236 also adds a virtual object V13 corresponding to “non-reserved” to a region corresponding to a program whose status information is “non-reserved”. The display control unit 236 also adds a virtual object V14 corresponding to “reserved” to a region corresponding to a program whose status information is “reserved”.

Virtual objects added by the display control unit 236 are stored by, for example, a storage unit of the mobile terminal 20. If virtual objects are stored for each type of status information, the display control unit 236 virtual objects related to status information can be added to regions. The virtual object may be in text form or image form.

In the example shown in FIG. 7, the virtual object V11 is represented by characters “Play back”, but may be represented by an abbreviated character of “Play back” (for example, “P”). The virtual object V11 may also be represented by a symbol indicating the playback. Similarly, the virtual object V12 is represented by characters “Delete”, but may be represented by an abbreviated character of “Delete” (for example, “D”). The virtual object V12 may also be represented by a symbol indicating the deletion.

Similarly, the virtual object V13 is represented by characters “Reserve To Record”, but may be represented by an abbreviated character of “Reserve To Record” (for example, “R”). The virtual object V13 may also be represented by a symbol indicating the recording reservation. Similarly, the virtual object V14 is represented by characters “Cancel Reservation”, but may be represented by an abbreviated character of “Cancel Reservation” (for example, “C”). The virtual object V14 may also be represented by a symbol indicating the cancel reservation.

Further, as shown in FIG. 7, the display control unit 236 may add the current time to the real object. For example, the mobile terminal 20 can acquire the current time from a clock installed inside or outside the mobile terminal 20 to add the acquired current time to the real object. Also, as shown in FIG. 7, a line may be added to the position corresponding to the current time in the real object. If such information is added, programs whose broadcasting will start, programs whose broadcasting has started, and programs whose broadcasting has finished can easily be recognized.

In the example shown in FIG. 7, for example, if a user operation on the virtual object V11 is detected by the operation detection unit 240, the execution control unit 244 controls execution of “playback” of the program. If a user operation on the virtual object V12 is detected by the operation detection unit 240, the execution control unit 244 controls execution of “deletion” of the program. If a user operation on the virtual object V13 is detected by the operation detection unit 240, the execution control unit 244 controls execution of “recording reservation” of the program. If a user operation on the virtual object V14 is detected by the operation detection unit 240, the execution control unit 244 controls execution of “cancel reservation” of the program.

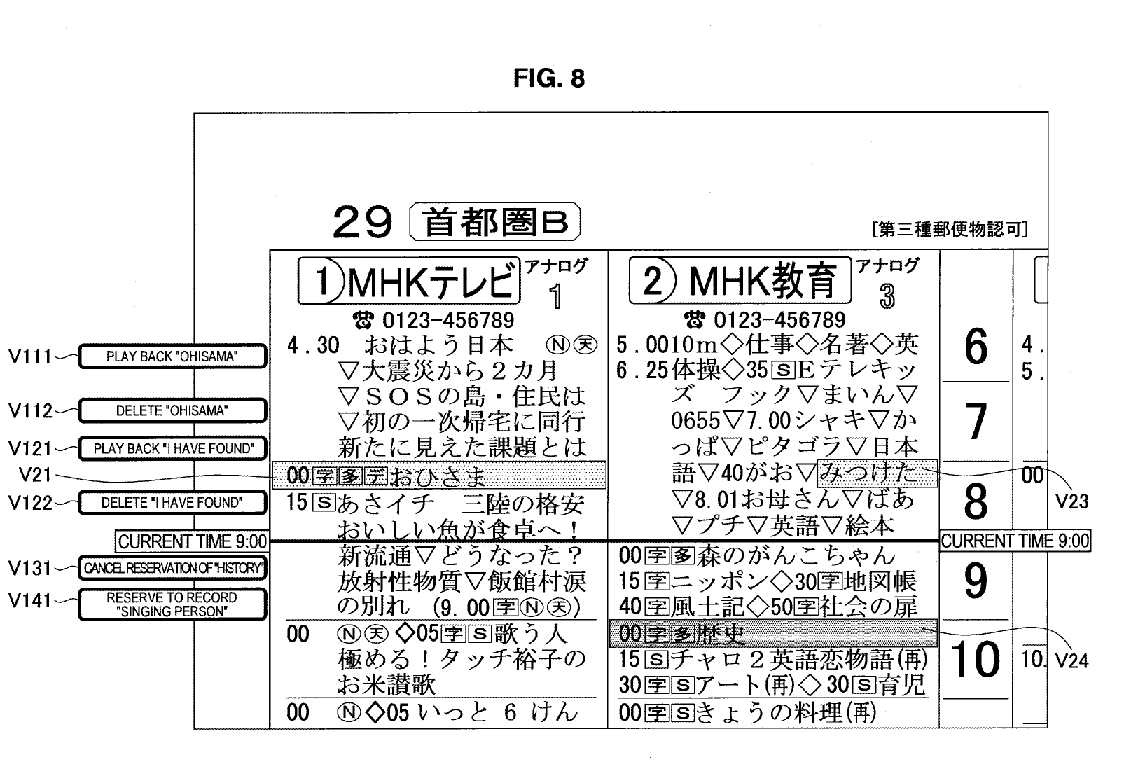

Another example of the display of the virtual object will be described with reference to FIG. 8. FIG. 8 is an explanatory view showing another example of the display of the virtual object. In the example shown in FIG. 8, the display control unit 236 adds virtual objects to columns in the left margin of the program table 40 as an example of regions corresponding to programs.

The display control unit 236 adds virtual objects V111, V112 formed from a combination of the program title (for example, “Ohisama”, “I Have Found” and the like) and “recorded” to regions corresponding to programs whose status information is “recorded”. The display control unit 236 also adds a virtual object V141 formed from the combination of the program title (for example, “Singing Person” and the like) and “non-reserved” to a region corresponding to a program whose status information is “non-reserved”. The display control unit 236 also adds a virtual object V131 formed from the combination of the program title (for example, “History” and the like) and “reserved” to a region corresponding to a program whose status information is “reserved”.

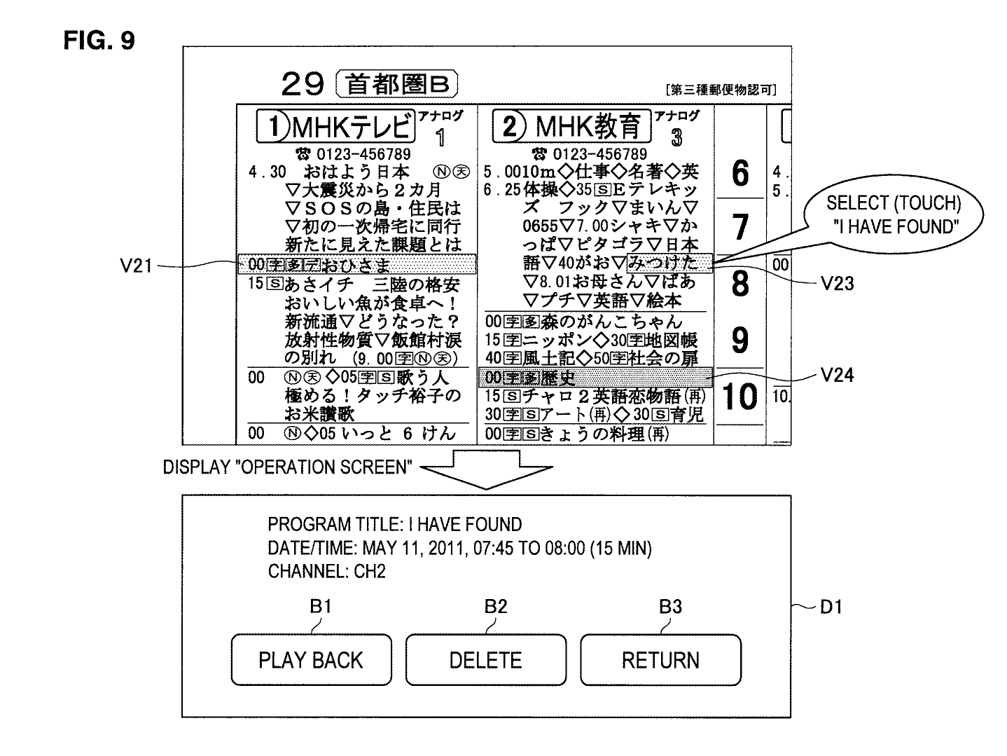

An example of the operation screen displayed by a user operation on a virtual object will be described with reference to FIG. 9. FIG. 9 is an explanatory view showing an example of the operation screen displayed by a user operation on a virtual object. In the example shown in FIG. 9, the display control unit 236 has added no virtual object to perform a user operation to a real object.

In the example shown in FIG. 9, instead, if a user operation on a virtual object V23 (virtual object added to a region corresponding to a program whose program title is “I Have Found”) is detected by the operation detection unit 240, the display control unit 236 can exercise control so that the operation screen for the program is displayed. The display control unit 236 can contain buttons to control execution of processing in accordance with status information of the program in the operation screen. If, for example, the status information of a program is “recorded”, the display control unit 236 can contain, as shown in FIG. 9, buttons B1, B2, B3 in the operation screen.

If, for example, a user operation on the button B1 is detected by the operation detection unit 240, the execution control unit 244 controls execution of “playback” of the program. If a user operation on the button B2 is detected by the operation detection unit 240, the execution control unit 244 controls execution of “deletion” of the program. If a user operation on the button B3 is detected by the operation detection unit 240, the execution control unit 244 exercises control so that the display of the real object is returned.

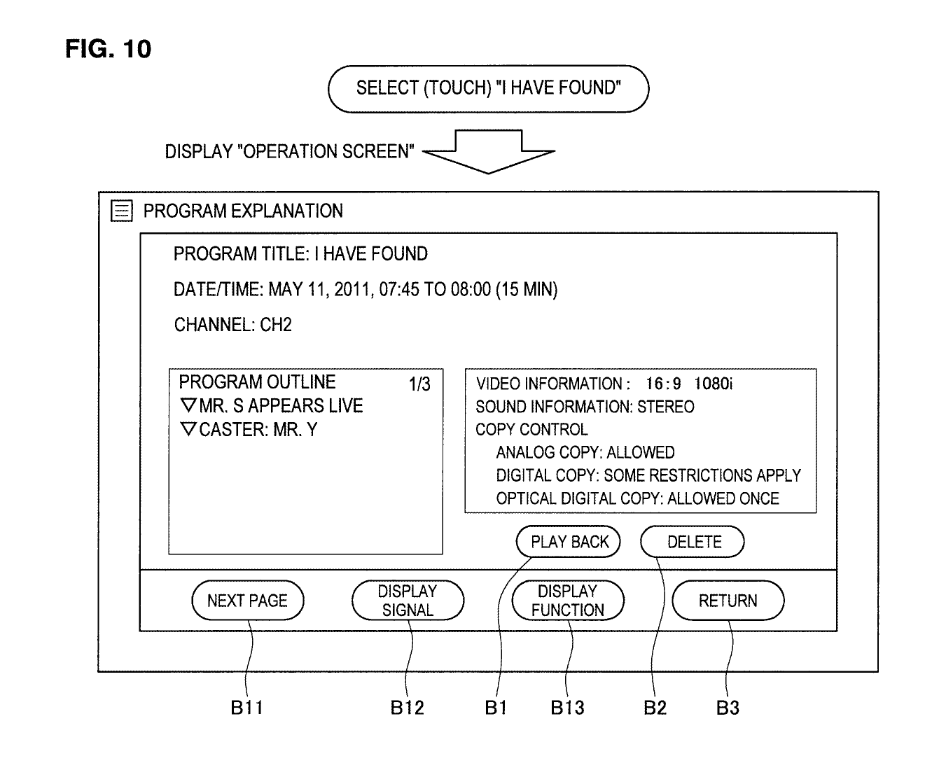

Subsequently, another example of the operation screen displayed by a user operation on a virtual object will be described with reference to FIG. 10. FIG. 10 is an explanatory view showing another example of the operation screen displayed by the user operation on a virtual object. In the example shown in FIG. 10, like the example shown in FIG. 9, the display control unit 236 has added no virtual object to perform the user operation to the real object.

Also in the example shown in FIG. 10, like the example shown in FIG. 9, if a user operation on the virtual object V23 is detected by the operation detection unit 240, the display control unit 236 can exercise control so that the operation screen for the program is displayed. If, like the example shown in FIG. 9, status information of a program is, for example, “recorded”, the display control unit 236 can contain, as shown in FIG. 10, the buttons B1 B2, B3 in the operation screen. In addition, the display control unit 236 can contain buttons B11, B12, B13 and the like in the operation screen.

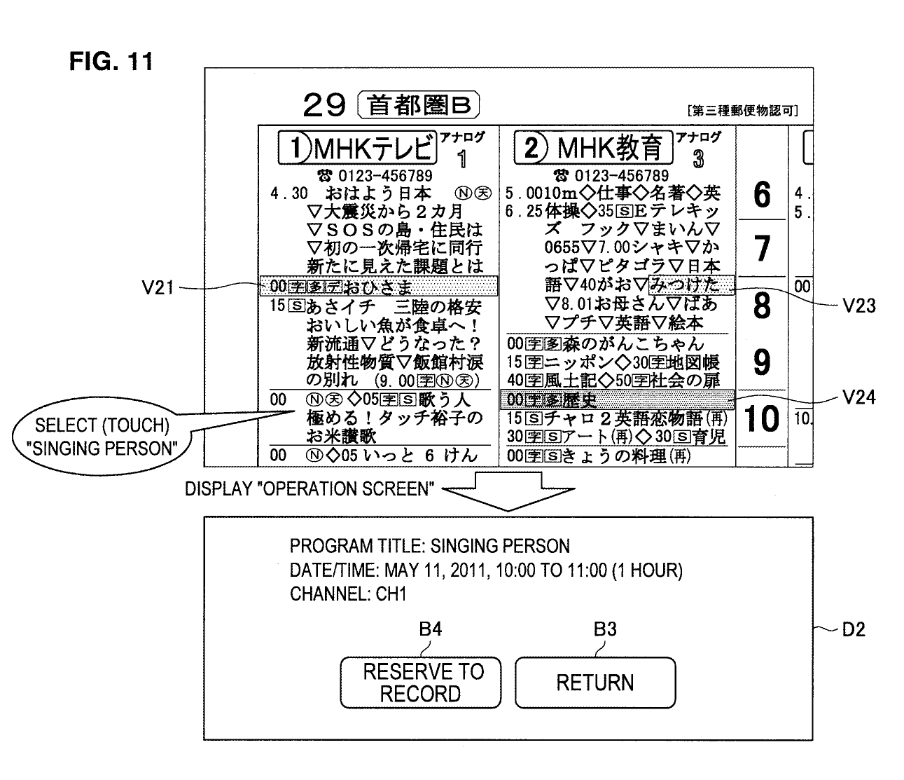

Subsequently, an example of the operation screen displayed by a user operation will be described with reference to FIG. 11. FIG. 11 is an explanatory view showing an example of the operation screen displayed by the user operation. In the example shown in FIG. 11, if the user operation on the region (region corresponding to the program whose program title is “Singing Person”) to which no virtual object is added is detected by the operation detection unit 240, the display control unit 236 can exercise control so that the operation screen for the program is displayed. The display control unit 236 can contain buttons to control execution of processing in accordance with status information of the program in the operation screen. If status information of the program is “non-reserved”, the display control unit 236 can contain, as shown in FIG. 11, buttons B4, B3 in the operation screen.

If, for example, a user operation on the button B4 is detected by the operation detection unit 240, the execution control unit 244 controls execution of “recording reservation” of the program. If a user operation on the button B3 is detected by the operation detection unit 240, the execution control unit 244 exercises control so that the display of a real object is returned.

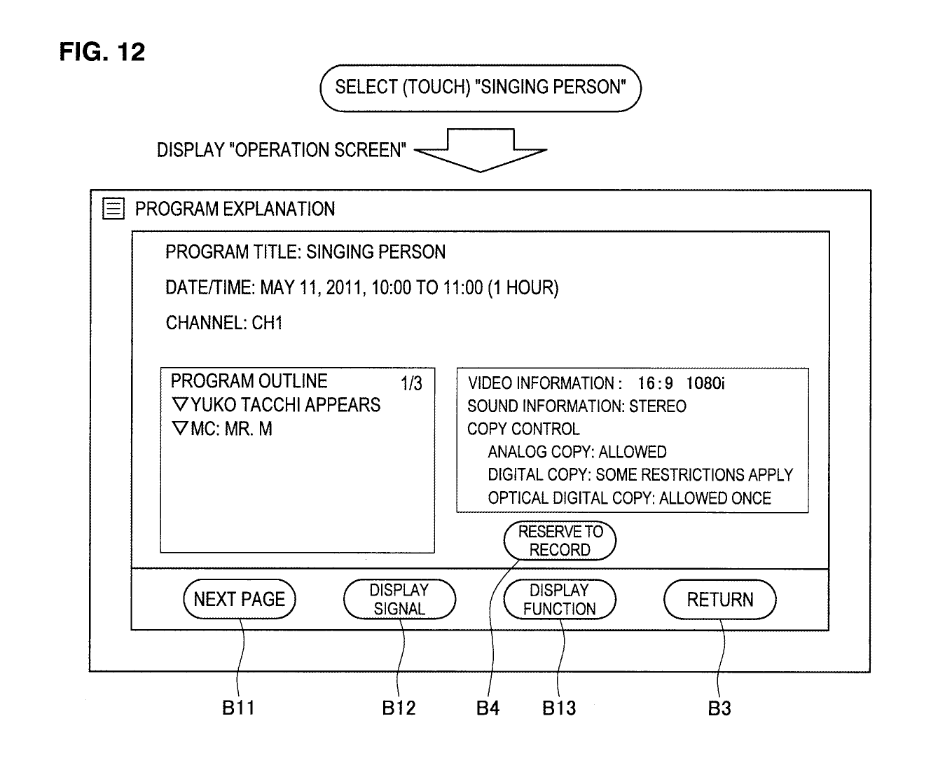

Subsequently, another example of the operation screen displayed by a user operation will be described with reference to FIG. 12. FIG. 12 is an explanatory view showing another example of the operation screen displayed by the user operation. In the example shown in FIG. 12, like the example shown in FIG. 11, if the user operation on the region (region corresponding to the program whose program title is “Singing Person”) to which no virtual object is added is detected by the operation detection unit 240, the display control unit 236 can exercise control so that the operation screen for the program is displayed.

Also in the example shown in FIG. 12, like the example shown in FIG. 11 if a user operation on a region to which no virtual object is added is detected by the operation detection unit 240, the display control unit 236 can exercise control so that the operation screen for the program is displayed. If, like the example shown in FIG. 11, status information of the program is “recorded”, the display control unit 236 can contain, as shown in FIG. 11, buttons B4, B3 in the operation screen. In addition, the display control unit 236 can contain buttons B11, B12, B13 and the like in the operation screen.

When, as described above, the user browses a real object containing region (for example, a region associated with the time), the mobile terminal 20 according to the present embodiment has a virtual object added to the region. Thus, the user can grasp a noteworthy region, and convenience for the user is enhanced.

(Operation of the Mobile Terminal)

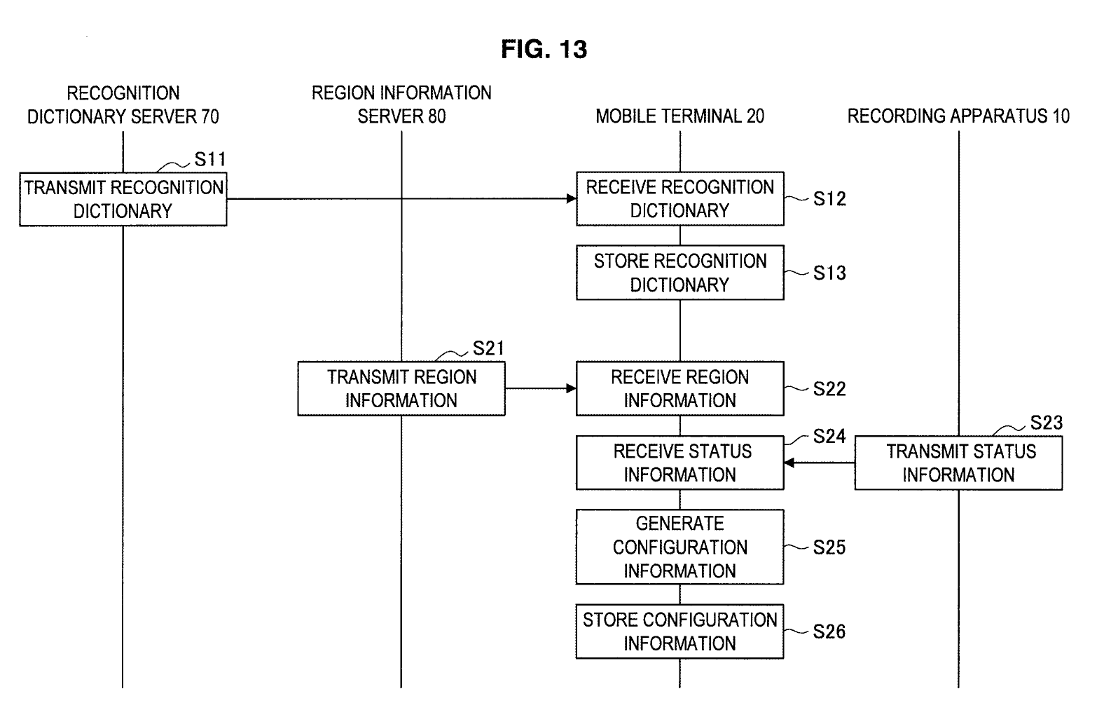

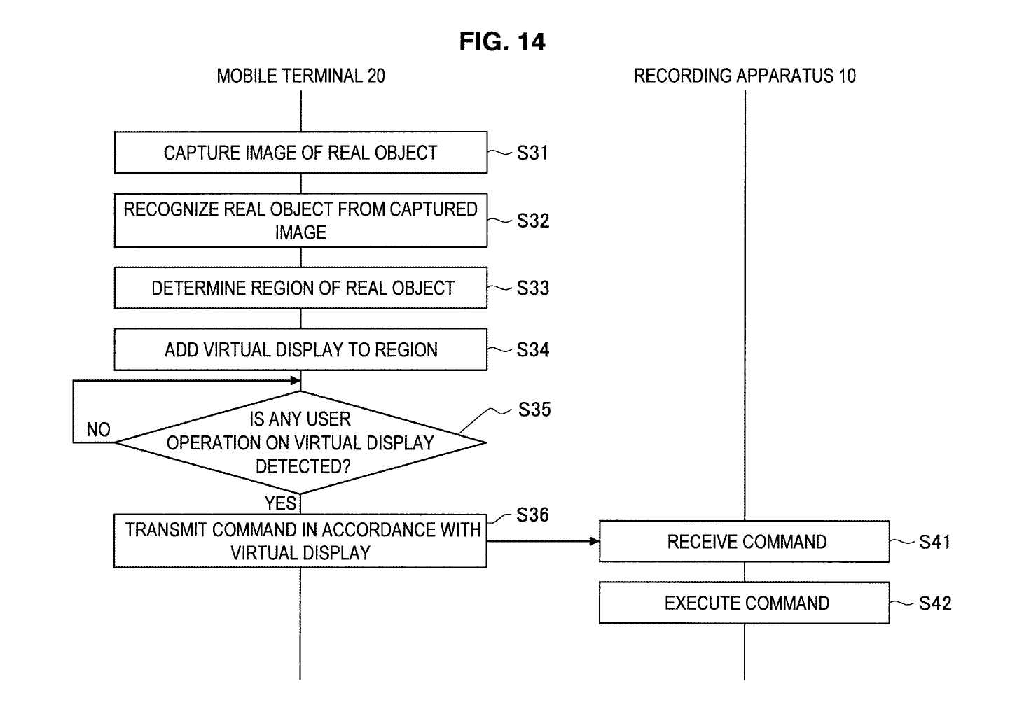

Subsequently, the operation of the mobile terminal 20 according to the present embodiment will be described with reference to FIGS. 13 and 14. FIG. 13 is a sequence diagram showing an operation performed before a real object being imaged.

In a stage before a real object being imaged, as shown in FIG. 13, the recognition dictionary server 70 transmits a recognition dictionary (S11). The recognition dictionary receiving unit 220 receives the recognition dictionary transmitted from the recognition dictionary server 70 (S12) and the recognition dictionary storage unit 222 stores the recognition dictionary received by the recognition dictionary receiving unit 220 (S13).

Subsequent to S11 to S13 or prior to S11 to S13, the region information server 80 transmits region information to the mobile terminal 20 (S21). Next, the region information receiving unit 226 receives the region information transmitted from the region information server 80 (S22). Subsequent to S21 and S22 or prior to S21 and S22, the recording apparatus 10 transmits status information (S23). Next, the status information receiving unit 224 receives the status information transmitted from the recording apparatus 10 (S24). The configuration information generation unit 228 generates configuration information based on the region information and status information (S25) and the configuration information storage unit 230 stores the configuration information generated by the configuration information generation unit 228 (S26).

FIG. 14 is a sequence diagram showing the operation after the real object being imaged. After the real object being imaged, as shown in FIG. 14, the imaging apparatus 213 first images the real object (S31). Next, the recognition unit 232 recognizes the real object from the captured image (S32) and the region determination unit 234 determines a region of the real object based on a recognition result by the recognition unit 232 and configuration information (S33). The display control unit 236 adds the virtual display to the real object determined by the region determination unit 234 (S34).

If no user operation on the virtual display is detected by the operation detection unit 240 (“NO” in S35), the execution control unit 244 exercises control so that the operation in S35 is repeated. If a user operation on the virtual display is detected by the operation detection unit 240 (“YES” in S35), the command transmitting unit 248 transmits a command corresponding to the virtual display to the recording apparatus 10 under the control of the execution control unit 244 (S36). When the command receiving unit 130 of the recording apparatus 10 receives the command from the mobile terminal 20 (S41), the command execution unit 140 executes the command received by the command receiving unit 130 (S42).

### 3. Conclusion

As described above, when the user browses a real object containing a region (for example, a region associated with the time), the mobile terminal 20 according to an embodiment of the present disclosure has a virtual object added to the region. Thus, the user can grasp a noteworthy region, and convenience for the user is enhanced. According to the mobile terminal 20 in an embodiment of the present disclosure, the user can quickly access desired information by an intuitive operation.

It should be understood by those skilled in the art that various modifications, combinations, sub-combinations and alterations may occur depending on design requirements and other factors insofar as they are within the scope of the appended claims or the equivalents thereof.

For example, the function to recognize a real object, the function to generate configuration information, and the function to determine a region, which are examples owned by the mobile terminal 20, have mainly been described above, but such functions may be owned by a server instead. If, for example, the mobile terminal 20 transmits a captured image to a server, instead of the mobile terminal 20, the server may recognize the real object from the captured image. Also, instead of the mobile terminal 20, for example, the server may generate configuration information. Also, instead of the mobile terminal 20, for example, the server may determine the region. Therefore, the technology according to an embodiment of the present disclosure can be applied to cloud computing.

For example, the motion of the mobile terminal 20 detected by an operation to the touch panel 27 detected by the touch panel 27 has been described as a detection example of a user operation serving as a trigger to a transition to the still image operation mode above, but the user operation is not limited to such an example. Detection by a motion sensor and gesture recognition of a user can be cited as other detection examples of a user operation. A gesture of the user can be recognized based on an image acquired by the imaging apparatus 213 or based on an image acquired by another imaging system. The imaging apparatus 213 or the other imaging system may image the user's gesture by the function of an infrared camera, a depth camera or the like.

In the above embodiment, an example in which the display control apparatus is the mobile terminal 20 has mainly been described, but the display control apparatus may be an apparatus such as a TV set or display apparatus that is relatively larger than the mobile terminal 20. For example, by connecting or containing an imaging apparatus that images the user from the side of the display control apparatus and using a large display capable of displaying the whole body of the user, a function like a mirror that displays the user can be configured to realize an AR application such as superimposing a virtual object on the user to allow the virtual object to be operated.

An example in which a command from the mobile terminal 20 is executed by the recording apparatus 10 has mainly been described above, but instead of the recording apparatus 10, an apparatus capable of executing the command may be used. For example, instead of the recording apparatus 10, a household electrical appliance (for example, an imaging apparatus, video playback apparatus or the like) may be used. In such a case, the command may be a command that allows content data (such as still images, motion images and the like) to be displayed or a command that causes the deletion of content data.

An example in which the program table 40 is used as a real object has mainly been described above, but instead of the program table 40, a calendar, schedule table or the like may be used as the real object. The schedule table may be an attendance management table or an employee schedule management table used in a company.

An example in which the mobile terminal 20 transmits a command to the recording apparatus 10 when a user operation on a virtual object is detected has mainly been described above, but the command may also be transmitted to the display apparatus 50. In such a case, the command to be transmitted may be a change to the channel corresponding to the virtual object on which the user operation has been performed.

Each step in the operation of the mobile terminal 20 or the recording apparatus 10 herein does not need necessarily to be processed in chronological order described as a sequence diagram. For example, each step in the operation of the mobile terminal 20 or the recording apparatus 10 may be processed in an order different from the order described as a sequence diagram or in parallel.

A computer program causing hardware such as a CPU, ROM, and RAM contained in the mobile terminal 20 or the recording apparatus 10 to exhibit the function equivalent to the function of each component of the mobile terminal 20 or the recording apparatus 10 can be created. Also, a storage medium caused to store the computer program may be provided.

Additionally, the present technology may also be configured as below.
(1)
A display control apparatus, including:

a display control unit that adds a virtual display to a real object containing a region associated with a time,

wherein the display control unit adds the virtual display to the region.
(2)
The display control apparatus according to (1),

wherein the real object is a program table containing a plurality of regions associated with broadcasting hours and channels.
(3)
The display control apparatus according to (1) or (2),

wherein the display control unit adds the virtual display in accordance with information stored about a program to the region corresponding to the program.
(4)
The display control apparatus according to any one of (1) to (3),

wherein when the information stored about the program indicates that the program has been recorded, the display control unit adds the virtual display to control a playback of the recorded program.
(5)
The display control apparatus according to any one of (1) to (3),

wherein when the information stored about the program indicates that the program has been recorded, the display control unit adds the virtual display to control a deletion of the recorded program.
(6)
The display control apparatus according to any one of (1) to (3),

wherein when the information stored about the program indicates that the program is non-reserved, the display control unit adds the virtual display to control a recording reservation of the program.
(7)
The display control apparatus according to any one of (1) to (3),

wherein when the information stored about the program indicates that the program is reserved, the display control unit adds the virtual display to control a cancel reservation of the program.
(8)
The display control apparatus according to any one of (1) to (7), further including:

an operation detection unit that detects a user operation on the virtual display; and

an execution control unit that controls execution of processing in accordance with the user operation.
(9)
The display control apparatus according to (8),

wherein the execution control unit further includes controlling the execution of the processing corresponding to the virtual display when the user operation on the virtual display is detected by the operation detection unit.
(10)
The display control apparatus according to any one of (1) to (9), further including:

a recognition unit that recognizes the real object from a captured image of the real object; and

a region determination unit that determines the region in the captured image.
(11)
A display control method, including: adding a virtual display to a region of a real object containing the region associated with a time
(12)
A program causing a computer to function as a display control apparatus including:

a display control unit that adds a virtual display to a real object containing a region associated with a time,

wherein the display control unit adds the virtual display to the region.

The present disclosure contains subject matter related to that disclosed in Japanese Priority Patent Application JP 2011-137181 filed in the Japan Patent Office on Jun. 21, 2011, the entire content of which is hereby incorporated by reference.

What is claimed is:

1. A display control apparatus, comprising:
a display control unit that adds a virtual display to a real object containing a region associated with a time,
wherein the display control unit adds the virtual display to the region.

2. The display control apparatus according to claim 1,
wherein the real object is a program table containing a plurality of regions associated with broadcasting hours and channels.

3. The display control apparatus according to claim 2,
wherein the display control unit adds the virtual display in accordance with information stored about a program to the region corresponding to the program.

4. The display control apparatus according to claim 3,
wherein when the information stored about the program indicates that the program has been recorded, the display control unit adds the virtual display to control a playback of the recorded program.

5. The display control apparatus according to claim 3,
wherein when the information stored about the program indicates that the program has been recorded, the display control unit adds the virtual display to control a deletion of the recorded program.

6. The display control apparatus according to claim 3,
wherein when the information stored about the program indicates that the program is non-reserved, the display control unit adds the virtual display to control a recording reservation of the program.

7. The display control apparatus according to claim 3,
wherein when the information stored about the program indicates that the program is reserved, the display control unit adds the virtual display to control a cancel reservation of the program.

8. The display control apparatus according to claim 1, further comprising:
an operation detection unit that detects a user operation on the virtual display; and
an execution control unit that controls execution of processing in accordance with the user operation.

9. The display control apparatus according to claim 8,
wherein the execution control unit further includes controlling the execution of the processing corresponding to the virtual display when the user operation on the virtual display is detected by the operation detection unit.

10. The display control apparatus according to claim 1, further comprising:
a recognition unit that recognizes the real object from a captured image of the real object; and
a region determination unit that determines the region in the captured image.

11. A display control method, comprising: adding a virtual display to a region of a real object containing the region associated with a time

12. A program causing a computer to function as a display control apparatus comprising:
a display control unit that adds a virtual display to a real object containing a region associated with a time,
wherein the display control unit adds the virtual display to the region.
